(19) United States
(12) Patent Application Publication
(10) Pub. No.: US 2008/0179145 A1
(43) Pub. Date: Jul. 31, 2008

(54) APPARATUS FOR GENERATING BRAKE PEDAL RESISTANCE

(75) Inventors: Tetsuya Miyazaki, Toyota-shi (JP); Takahiro Okano, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/015,131

(22) Filed: Jan. 16, 2008

(30) Foreign Application Priority Data
Jan. 25, 2007 (JP) 2007-014546

(51) Int. Cl. B60T 7/06; B60T 17/00

(52) U.S. Cl. 188/151 R; 303/1

(57) ABSTRACT

An apparatus that generates brake pedal reaction force is provided. The apparatus includes a variable throttle mechanism that varies a fluid passage area between the variable throttle mechanism and a stroke simulator when the flow rate of an operating fluid supplied from a master cylinder exceeds a predetermined flow rate. The variable throttle mechanism includes a movable member, in which a through passage for the operating fluid is formed, and a throttle portion that is formed in the middle of the through passage. The movable member is slidably provided in the inside of a case body and the movable member changes the fluid passage area by closing a portion of a communicating port formed in the case body.

### INCORPORATION BY REFERENCE

This disclosure of Japanese Patent Application No. 2007-014546, filed on Jan. 25, 2007, including the specification, drawings, and abstract is incorporated by reference in its entirety.

### BACKGROUND OF THE INVENTION

1. Field of the Invention

The present invention relates to an apparatus for generating a brake pedal resistance in response to a driver's depression of the brake pedal and, more particularly, to an apparatus for generating brake pedal resistance that includes a stroke simulator.

2. Description of the Related Art

In a brake apparatus, a stroke simulator is generally used in order for a driver to feel comfortable when braking. For example, a construction that includes a simulator control valve provided between a master cylinder and the stroke simulator is described in Japanese Laid Open Patent Publication No. 2003-112617 (JP 2003-112617-A). By varying the current supplied to the simulator control valve, inflow resistance to fluid that flows from the master cylinder to the stroke simulator may be adjusted. This allows the relation between a depression force and a pedal stroke to be controlled.

In a brake control apparatus that includes a vacuum booster, when the depression speed of a brake pedal is increased, the depression force of the brake pedal is increased. Meanwhile, an orifice, instead of the vacuum booster, is used in the brake control apparatus to which an electronic control type brake system (ECB) is applied, wherein the orifice is arranged between the master cylinder and the stroke simulator. In this case, a relation between an increase amount by which a resistance of the brake pedal increases (AF) and the depression speed (V) of the brake pedal conforms to a flow rate formula of the orifice. Specifically, the ΔF is proportional to the V². Under this relation, when the depression speed of the brake pedal is low, the brake pedal resistance is higher than a driver's desired brake pedal resistance and the brake pedal feels heavy. On the other hand, if the depression speed of the brake pedal is increased, the brake pedal resistance is low than a driver's desired brake pedal resistance and the brake pedal feels light. Particularly, when the brake pedal is quickly depressed, the driver may feel that the brake pedal is heavy and strongly resists moving when the pedal is initially depressed during which the depression speed of the brake pedal is small. This results in an uncomfortable braking feel. Thus, it is necessary to generate a suitable brake pedal resistance in accordance with the depression speed.

The brake control apparatus described in JP 2003-112617-A, is designed to determine whether the pedal is suddenly depressed in response to the depression force and the depression stroke. There is no consideration for the relation between the depression speed of the brake pedal and the brake pedal resistance. As shown in JP 2003-112617-A, when the simulator control valve of the current drive changes the inflow resistance, the cost is increased and a response to feedback control may be delayed.

### SUMMARY OF THE INVENTION

The present invention provides an apparatus for generating a brake pedal resistance force that stably provides a comfortable braking feel.

An apparatus that generates a brake pedal resistance in accordance with an aspect of the present invention comprises: a variable throttle mechanism coupled to an operating fluid supply passage that supplies an operating fluid from a master cylinder; and a stroke simulator for communicating with the variable throttle mechanism, wherein the brake pedal resistance generating apparatus generates a brake pedal resistance in accordance with the operation of the brake pedal by the driver. The variable throttle mechanism varies a fluid passage area when the flow rate of the operating fluid supplied from the master cylinder exceeds a predetermined flow rate. According to this aspect, it is possible to stably obtain a comfortable braking feel by varying the fluid passage area in response to the supply flow rate of the operating fluid by using the variable throttle mechanism.

In an apparatus for generating brake pedal resistance in accordance with an aspect of the present invention, the variable throttle mechanism may vary the fluid passage area between the variable throttle mechanism and the stroke simulator. The resistance generated by the stroke simulator may be properly controlled by varying the fluid passage area directly communicating with the stroke simulator. Alternatively, the variable throttle mechanism may vary the fluid passage area on the master cylinder side.

In an apparatus for generating brake pedal resistance in accordance with an aspect of the present invention, the variable throttle mechanism may include a movable member in which a passage is formed through which the operating fluid flows and in which a throttle portion is formed. A differential pressure is generated between the front and the rear of the movable member in response to the flow rate of the operating fluid by forming the throttle portion in the through passage of the inside of the movable member. This allows the movable member to move.

In an apparatus for generating brake pedal resistance in accordance with an aspect of the present invention, the movable member may be slidably mounted in within a case body and the movable member varies the fluid passage area by closing a portion of a communicating port formed in the case body. Thus, it is possible to constitute the variable throttle mechanism with a relatively simple structure.

In an apparatus for generating brake pedal resistance in accordance with an aspect of the present invention, it is preferable that the variable throttle mechanism includes a pressing unit that presses the movable member in a predetermined position within the case body and the distance from the predetermined position to the communicating port is set in a predetermined distance. The predetermined distance is set in a distance greater than zero (0). Therefore, the movable member moves the distance from the predetermined position to the communicating port until the brake pedal is depressed by a predetermined amount. The brake pedal may be depressed relatively lightly until the movable member closes a portion of the communicating port. Also, it is possible to prevent the brake pedal resistance from suddenly increasing, right after the brake pedal is depressed. It is preferable that the pressing unit is one or more springs and the predetermined distance is set according to spring modulus.

In accordance with the aspects of the invention, it may be stably obtain a comfortable braking feeling.

### BRIEF DESCRIPTION OF THE DRAWINGS

The above and other features and advantages of the present invention will become apparent from the following description of example embodiments, given in conjunction with the accompanying drawings, in which:

FIG. 1 is a schematic diagram showing a brake control apparatus in accordance with an embodiment of the present invention;

FIG. 2 is a graph showing a relation between an increase amount by which brake pedal resistance increases (ΔF) and a depression speed (V) of the brake pedal;

FIG. 3A and FIG. 3B are views showing the inner structure of a variable throttle mechanism; and

FIG. 4 is a graph showing the relation between the pedal stroke and the pedal depression force.

### DETAILED DESCRIPTION OF THE EMBODIMENTS

Various embodiments of the present invention will now be described in detail with reference to the accompanying drawings.

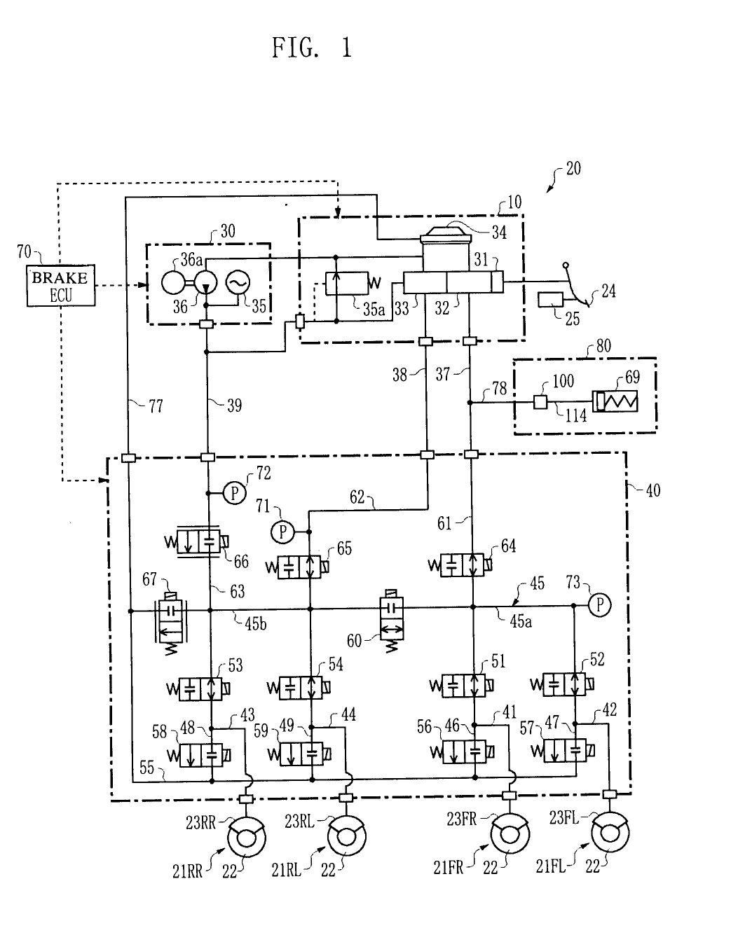

FIG. 1 is a schematic diagram showing a brake control apparatus 20 for a vehicle in accordance with an embodiment of the present invention. The brake control apparatus 20 shown in FIG. 1 includes an electronically controlled brake system (ECB) and controls braking forces applied to each wheel of the vehicle. The brake control apparatus 20 according to the present embodiment may be mounted, for example, on a hybrid vehicle that uses an electric motor and an internal combustion engine as power sources to propel the vehicle. In the hybrid vehicle, regenerative braking, in which the kinetic energy of the vehicle is converted to electrical energy, and hydraulic braking, controlled by the brake control apparatus 20, are both used to brake the vehicle. In the vehicle according to the present embodiment, regenerative braking may be used together with the hydraulic braking to execute a cooperative braking control to generate the desired braking force.

As shown in FIG. 1, the brake control apparatus 20 includes disk brake units 21FR, 21FL, 21RR, and 21RL, a master cylinder unit 10, a power hydraulic source 30, and a hydraulic actuator 40, wherein each of the disk brake units 21FR, 21FL, 21RR, and 21RL is provided to the corresponding wheel.

The disk brake units 21FR, 21FL, 21RR, and 21RL apply the braking force to a front-right wheel, a front-left wheel, a rear-right wheel, and a rear-left wheel, respectively. In the present embodiment, the master cylinder unit 10 serves as a manual hydraulic pressure source that transmits brake fluid, which is pressurized in accordance with a depression amount of a brake pedal 24, which serves as a brake operation member, to the disk brake units 21FR˜21RL. The power hydraulic pressure source 30 is powered by a power supply and pressurizes the brake fluid, which serves as an operating fluid. The power hydraulic pressure source 30 then supplies the pressurized brake fluid to the disk brake units 21FR˜21RL, independently of a driver's depression of the brake pedal 24. The hydraulic actuator 40 adjusts properly the pressure of the brake fluid supplied from the power hydraulic pressure source 30 or the master cylinder unit 10 and supplies the brake fluid to the disk brake units 21FR˜21RL. Accordingly, the braking force with respect to each wheel may be adjusted through the hydraulic braking system.

In the following, the disk brake units 21FR˜21RL, the master cylinder unit 10, the power hydraulic pressure source 30, and the hydraulic actuator 40 will be described in detail, respectively. Each of the disk brake units 21FR˜21RL includes a brake disk 22 and wheel cylinders 23FR, 23FL, 23RR, and 23RL installed in brake calipers, respectively. Each of the wheel cylinders 23FR˜23RL is connected to the hydraulic actuator 40 through a separate fluid passage. Hereinafter, the wheel cylinders 23FR˜23RL are referred to as “wheel cylinder 23” in general for convenience.

In the disk brake units 21FR˜21RL, when the brake fluid is supplied from the hydraulic actuator 40 to the wheel cylinder 23, a brake pad, which serves as a friction member, is pressed to the brake disk 22 that rotates together with the wheel. As a result, braking force is applied to each wheel. Though the disk brake units 21FR˜21RL are used in the present embodiment, other braking force application devices that include the wheel cylinder 23, for example, a drum brake, etc. may be used.

The master cylinder unit 10 used in the present embodiment includes an attached hydraulic brake booster 31, a master cylinder 32, a regulator 33, and a reservoir 34. The hydraulic brake booster is connected to the brake pedal 24. The hydraulic brake booster 31 amplifies the depression force applied to the brake pedal 24 and transfers it to the master cylinder 32. The brake fluid is supplied to the hydraulic brake booster 31 through the regulator 33 from the power hydraulic pressure source 30, and thus the depression force is amplified. The master cylinder 32 generates a master cylinder pressure that has a predetermined boost ratio with respect to the depression force.

The reservoir 34 retaining the brake fluid is installed on the upper portion of the master cylinder 32 and the regulator 33. For example, the pressure in the reservoir 34 is atmospheric pressure. When the brake pedal 24 is released, the master cylinder 32 is communicated with the reservoir 34. The regulator 33 is communicated with both sides of the reservoir 34 and an accumulator 35 in the power hydraulic pressure source 30. The reservoir 34 is used as a low pressure source and the accumulator 35 is used as a high pressure source, and the regulator 33 generates pressure that is nearly the same as the master cylinder pressure.

The power hydraulic pressure source 30 includes the accumulator 35 and a pump 36. The accumulator 35 converts pressure energy of the brake fluid boosted by the pump 36 into pressure energy of a gas such as nitrogen, etc., for example, 14 MPa˜22 MPa or so. The accumulator 35 accumulates the converted pressure energy. A motor 36a is used to drive the pump 36. The inlet of the pump 36 is connected to the reservoir 34 and the outlet of the pump 36 is connected to the accumulator 35. The accumulator 35 is also connected to a relief valve 35a provided to the master cylinder unit 10. When the brake fluid pressure in the accumulator 35 reaches, for example, 25 MPa or so, the relief valve 35a opens and the brake fluid of increased pressure returns to the reservoir 34.

As described above, the brake control apparatus 20 includes the master cylinder 32, the regulator 33, and the accumulator 35, which serves as a brake fluid supply source for the wheel cylinders 23. A master conduit 37 is connected to the master cylinder 32, a regulator conduit 38 is connected to the regulator 33, and an accumulator conduit 39 is connected to the accumulator 35. Each of the master conduit 37, the regulator conduit 38, and the accumulator conduit 39 are connected to the hydraulic actuator 40.

The hydraulic actuator 40 includes an actuator block in which plural fluid passages are formed, and a plurality of electromagnetic control valves. The plural fluid passages formed in the actuator block include a main fluid passage 45 and individual fluid passages 41, 42, 43, and 44. Each individual fluid passage 41˜44 branches from the main fluid passage 45. The individual fluid passages 41˜44 are connected to the corresponding wheel cylinders 23FR, 23FL, 23RR, and 23RL of the disk brake units 21 FR, 21FL, 21RR, and 21RL, respectively. Accordingly, each wheel cylinder 23 may communicate with the main fluid passage 45.

ABS holding valves 51, 52, 53, and 54 are provided on the middle portions of the individual fluid passages 41, 42, 43, and 44, respectively. Each of the ABS holding valves 51˜54 includes a solenoid controlled as ON/OFF and a spring. Each of the ABS holding valves 51˜54 is a normally open electromagnetic control valve. When each of the ABS holding valves 51˜54 is open, the brake fluid is able to flow through the valve in either direction. That is, the ABS holding valves may allow the brake fluid to flow from the main passage 45 to the wheel cylinder 23 or from the wheel cylinder 23 to the main fluid passage 45. When the solenoid is energized and each of the ABS holding valves 51˜54 is closed, flow of the brake fluid through the individual fluid passages 41˜44 is to be cutoff.

The wheel cylinder 23 is connected to a reservoir fluid passage 55 through pressure reducing passages 46, 47, 48, and 49 respectively connected to the individual fluid passages 41˜44. ABS pressure reducing valves 56, 57, 58, and 59 are provided on the middle portions of the pressure reducing passages 46, 47, 48, and 49, respectively. Each of the ABS pressure reducing valves 56˜59 includes a solenoid controlled as ON/OFF and a spring. Each of the ABS pressure reducing valves 56˜59 is a normally closed electromagnetic control valve. When each ABS pressure reducing valve 56˜59 is closed, the flow of the brake fluid through the pressure reducing passages 46˜49 is to be cutoff. When a solenoid is energized and each of the ABS pressure reducing valves 56˜59 is opened, the flow of the brake fluid through the pressure reducing passages 46˜49 is allowed. As a result, the brake fluid flows backward from the wheel cylinder 23 to the reservoir 34 through the pressure reducing passages 46˜49 and the reservoir fluid passage 55. The reservoir fluid passage 55 is connected to the reservoir 34 of the master cylinder unit 10 through a reservoir conduit 77.

A separating valve 60 is provided on the middle portion of the main fluid passage 45. The main fluid passage 45 is divided into a first fluid passage 45a and a second fluid passage 45b by the separating valve 60, wherein the first fluid passage 45a is connected to the individual fluid passages 41 and 42 and the second fluid passage 45b is connected to the individual fluid passages 43 and 44. The first fluid passage 45a is connected to the wheel cylinders 23FR and 23FL for front wheels through the individual fluid passages 41 and 42. The second fluid passage 45b is connected to the wheel cylinders 23RR and 23RL for rear wheels through the individual fluid passages 43 and 44.

The separating valve 60 includes a solenoid controlled as ON/OFF and a spring. The separating valve 60 is a normally closed electromagnetic control valve. When the separating valve 60 is closed, the flow of the brake fluid through the main fluid passage 45 is cutoff. When the solenoid is energized and the separating valve 60 is open, the brake fluid is able to flow bidirectionally between the first fluid passage 45a and the second fluid passage 45b.

Further, a master fluid passage 61 and a regulator fluid passage 62, which communicate with the main fluid passage 45, are formed on the hydraulic actuator 40. In greater detail, the master fluid passage 61 is connected to the first fluid passage 45a of the main fluid passage 45 and the regulator fluid passage 62 is connected to the second fluid passage 45b of the main fluid passage 45. The master fluid passage 61 is connected to the master conduit 37. The regulator fluid passage 62 is connected to the regulator conduit 38.

A master cut valve 64 is provided on the middle portion of the master fluid passage 61. The master cut valve 64 is provided on a brake fluid supply path that extends from the master cylinder 32 to each wheel cylinder 23. The master cut valve 64 includes a solenoid controlled as ON/OFF and a spring. The master cut valve 64 closed through an electromagnetic force that is generated by the solenoid receiving the prescribed control current. The master cut valve is a normally open electromagnetic control valve. An open master cut valve 64 allows the brake fluid to flow in either direction between the master cylinder 32 and the first fluid passage 45a of the main fluid passage 45. When the prescribed control current energizes the solenoid and the master cut valve 64 is closed, the flow of the brake fluid in the master fluid passage 61 is cutoff.

A regulator cut valve 65 is provided on the middle portion of the regulator fluid passage 62. The regulator cut valve 65 is arranged on a brake fluid supply path provided from the regulator 33 to the respective wheel cylinder 23. The regulator cut valve 65 also includes a solenoid controlled as ON/OFF and a spring. The regulator cut valve 65 is closed through an electromagnetic force that is generated by the solenoid receiving the prescribed control current. The regulator cut valve 65 is a normally open electromagnetic control valve that is open when the solenoid is de-energized. When the regulator cut valve 65 is open, the brake fluid is able to flow in either direction between the regulator 33 and the second fluid passage 45b of the main fluid passage 45. When the solenoid is energized and the regulator cut valve 65 is closed, the flow of the brake fluid in the regulator fluid passage 62 is cutoff.

An accumulator fluid passage 63 is also formed on the hydraulic actuator 40, in addition to the master fluid passage 61 and the regulator fluid passage 62. One end of the accumulator fluid passage 63 is connected to the second fluid passage 45b of the main fluid passage 45 and the other end of the accumulator fluid passage 63 is connected to the accumulator conduit 39.

A pressure increasing linear control valve 66 is provided on the middle portion of the accumulator fluid passage 63. The accumulator fluid passage 63 and the second fluid passage 45b of the main fluid passage 45 are connected to the reservoir fluid passage 55 through a pressure reducing linear control valve 67. The pressure increasing linear control valve 66 and the pressure reducing linear control valve 67 include a linear solenoid and a spring, respectively. Each of the pressure increasing linear control valve 66 and the pressure reducing linear control valve 67 is a normally closed electromagnetic control valves. The opening degrees of the pressure increasing linear control valve 66 and the pressure reducing linear control valve 67 are adjusted in proportion to the currents supplied to the respective solenoid thereof.

The pressure increasing linear control valve 66 is provided as a common control valve for increasing pressure with respect to each wheel cylinder 23 corresponding to the respective wheel. The pressure reducing linear control valve 67 is similarly provided as a common control valve for reducing pressure with respect to each wheel cylinder 23. That is, in the present embodiment, the pressure increasing linear control valve 66 and the pressure reducing linear control valve 67 are provided as a pair of common control valves for controlling the supply of operating fluid from the power hydraulic pressure source 30 to each wheel cylinder 23. When the pressure increasing linear control valve 66, etc. are provided to be common with respect to each wheel cylinder 23, it can reduce cost, compared with the case where a linear control valve is provided for each wheel cylinder 23.

In the brake control apparatus 20, the power hydraulic pressure source 30 and the hydraulic actuator 40 are controlled by a brake ECU 70. The brake ECU 70 consists of as a microprocessor including a CPU. The brake ECU 70 includes a ROM storing various programs, a RAM storing data temporally, input and output ports, a communication port, etc., in addition to the CPU. The brake ECU 70 communicates with a high level hybrid ECU (not shown), etc. The brake ECU 70 controls the pump 36 of the power hydraulic pressure source 30 or electromagnetic control valves 51˜54, 56˜59, 60, and 64˜67 by which the hydraulic actuator 40 is constituted, based on control signals from the hybrid ECU or signals from various sensors.

A regulator pressure sensor 71, an accumulator pressure sensor 72, and a control pressure sensor 73 are connected to the brake ECU 70. The regulator pressure sensor 71 detects the brake fluid pressure inside the regulator fluid passage 62 upstream of the regulator cut valve 65, i.e., a regulator pressure. The regulator pressure sensor 71 gives a signal indicating the detected pressure to the brake ECU 70. The accumulator pressure sensor 72 detects a brake fluid pressure inside the accumulator fluid passage 63 upstream of the pressure increasing linear control valve 66, i.e., a accumulator pressure. The accumulator pressure sensor 72 gives a signal indicating the detected pressure to the brake ECU 70. The control pressure sensor 73 detects a brake fluid pressure inside the first fluid passage 45a of the main fluid passage 45 and gives a signal indicating the detected pressure to the brake ECU 70. The detected pressures from each of pressure sensors 71˜73 are given to the brake ECU 70 at predetermined intervals in sequential order. The detected pressure from each pressure sensor 71˜73 is stored and maintained in a certain memory area of the brake ECU 70.

When the first fluid passage 45a and the second fluid passage 45b of the main fluid passage 45 are communicated with each other while the separating valve 60 is open, an output value from the control pressure sensor 73 indicates the hydraulic pressure on a low pressure side of the pressure increasing linear control valve 66 and also indicates the hydraulic pressure on a high pressure side of the pressure reducing linear control valve 67. Therefore, the output value from the control pressure sensor 73 may be used to control the pressure increasing linear control valve 66 and the pressure reducing linear control valve 67. When the pressure increasing linear control valve 66 and the pressure reducing linear control valve 67 are closed and the master cut valve 64 is open, an output value from the control pressure sensor 73 indicates the master cylinder pressure. Further, if each ABS pressure reducing valve 56˜59 is closed while each ABS holding valve 51˜54 is open and the first fluid passage 45a of the main fluid passage 45 is communicated with the second fluid passage 45b of the main fluid passage 45 while the separating valve 60 is open, an output value from the control pressure sensor 73 indicating a hydraulic pressure acting on each wheel cylinder 23, i.e., a wheel cylinder pressure.

The sensor connected to the brake ECU 70 further includes a stroke sensor 25 provided on the brake pedal 24. The stroke sensor 25 detects the amount by which the brake pedal 24 is depressed and gives a signal indicating the detected amount to the brake ECU 70. An output value from the stroke sensor 25 is also given to the brake ECU 70 at predetermined intervals and in sequential order. The output value from the stroke sensor 25 is stored and maintained in a certain memory area by a predetermined amount. A detection unit for detecting the depression of the brake pedal 24 is applied to the stroke sensor 25 or is provided instead of the stroke sensor 25, and thus the detection unit may be connected to the brake ECU 70. The detection unit for detecting the brake operation state includes, for example, a pedal force sensor for detecting the depression force of the brake pedal 24, a brake switch for detecting whether the brake pedal 24 is being depressed, etc.

The brake control apparatus 20 constituted as described above executes the cooperative braking control. The brake control apparatus 20 receives a braking signal and starts braking. The braking signal occurs when braking force needs to be applied to the vehicle, for example, such as when a driver depresses a brake pedal 24, etc. The brake ECU 70 receives a braking signal and calculates a target braking force. Subsequently, the brake ECU 70 computes a desired hydraulic braking force or a cooperative braking force that is generated from the brake control apparatus 20 by subtracting the regenerative braking force from the target braking force. The regenerative braking force by is supplied from the hybrid ECU to the brake control apparatus 20. The brake ECU 70 computes a target hydraulic pressure of each wheel cylinder 23FR˜23RL, based on the target hydraulic braking force which is computed. The brake ECU 70 determines the value of the control current supplied to the pressure increasing linear control valve 66 or the pressure reducing linear control valve 67 through a feedback control so that the wheel cylinder pressure is to be the target hydraulic pressure.

As a result, in the brake control apparatus 20, the brake fluid is supplied from the power hydraulic pressure source 30 to the respective wheel cylinder 23 through the pressure increasing linear control valve 66, and thus the braking force is applied to the wheel. The brake fluid, if necessary, may be discharged from the respective wheel cylinder 23 through the pressure reducing linear control valve 67, and thus the braking force applied to the wheel is adjusted. In the present embodiment, a wheel cylinder pressure control system includes the power hydraulic pressure source 30, the pressure increasing linear control valve 66, the pressure reducing linear control valve 67, etc. The wheel cylinder pressure control system is arranged in parallel on a brake fluid supply path provided from the master cylinder unit 10 to the wheel cylinder 23.

At this time, the brake ECU 70 closes the regulator cut valve 65 so that brake fluid is supplied from the regulator 33 to the wheel cylinder 23. When the brake pedal 24 is depressed, the brake ECU 70 closes the master cut valve 64 so that brake fluid is supplied from the master cylinder 32 to a brake pedal resistance generating apparatus 80 instead of the wheel cylinder 23. A differential pressure corresponding to the magnitude of the regenerative braking force acts between upstream and downstream of the regulator cut valve 65 and the master cut valve 64, during the cooperative braking control.

In the brake control apparatus 20 of the present embodiment, the pedal resistance generating apparatus 80 is connected to the master conduit 37 through a simulator fluid passage 78. The pedal resistance generating apparatus 80 generates a resistance in response to the depression of the brake pedal. The pedal resistance generating apparatus 80 includes a variable throttle mechanism 100 and a stroke simulator 69, wherein the variable throttle mechanism 100 is connected to the simulator fluid passage 78 or an operating fluid supply passage provided from the master cylinder 32 and the stroke simulator 69 communicates with the variable throttle mechanism 100 through communicating passage 114. The variable throttle mechanism 100 is a flow rate sensitive type throttle mechanism that adjusts the fluid passage area in response to flow rate of the brake fluid. The stroke simulator 69 receives the brake fluid supplied from the variable throttle mechanism 100 and generates a resistance in response to the depression of the brake pedal.

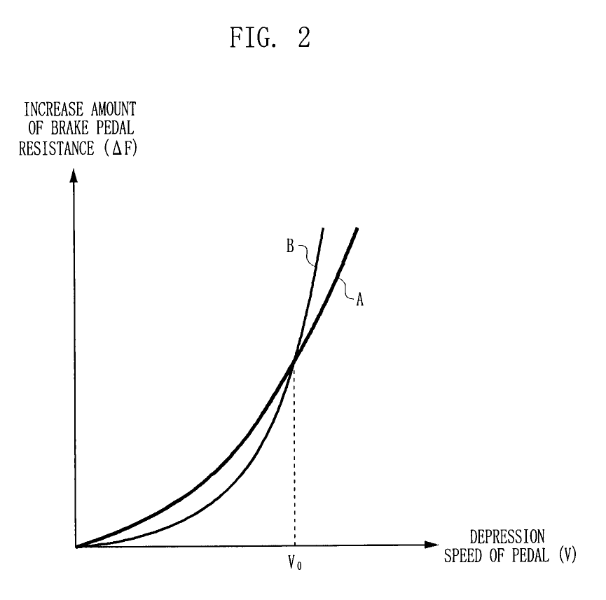

FIG. 2 represents a relation between the increase amount of the brake pedal resistance (AF) and the speed at which the brake pedal is operated. A depression force at which the driver is required to depress the pedal increases, as the brake pedal resistance increases. A characteristic curve A represents the relation derived from the case where a conventional orifice is used. The characteristic curve A conforms to a flow rate formula of the orifice, and thus the AF is proportional to the V². A characteristic curve B conceptually represents an ideal relation between the AF and the V, which may be determined empirically based on the driver's perception of brake feel.

Compared the characteristic curves A with the characteristic curves B, when the brake pedal depression speed is small (V<V₀), the brake pedal resistance directed from the orifice according to the brake pedal depression speed is larger than a target pedal resistance. Meanwhile, when the brake pedal depression speed is large (V>V₀), the brake pedal resistance is smaller than the target pedal resistance. A driver who quickly depresses the brake pedal 24 feels that the brake pedal is heavy and strongly resists moving when the depression speed of the brake pedal is small, that is, in the initial stage of depressing on the pedal. On the other hand, the driver feels that the brake pedal is light when the depression speed of the brake pedal is high.

Therefore, a characteristic of the pedal resistance generating apparatus 80 for obtaining a comfortable braking feel is required. Accordingly, it is preferable to reduce the brake pedal resistance in the initial stage of depressing the brake pedal than in use of the orifice. It is also preferable to relieve a feeling that the brake pedal 24 is pulled backward. It is also preferable to give a driver a feeling that the brake pedal is stepped in suitable magnitude when the brake pedal depression speed is increased while the driver further depresses the brake pedal 24. In the brake control apparatus 20 of the present embodiment, the pedal resistance generating apparatus 80 decreases the brake pedal resistance in the initial stage of depressing the pedal and also increases the brake pedal resistance when the pedal depression speed is high. The pedal resistance generating apparatus 80 may execute either operation as appropriate.

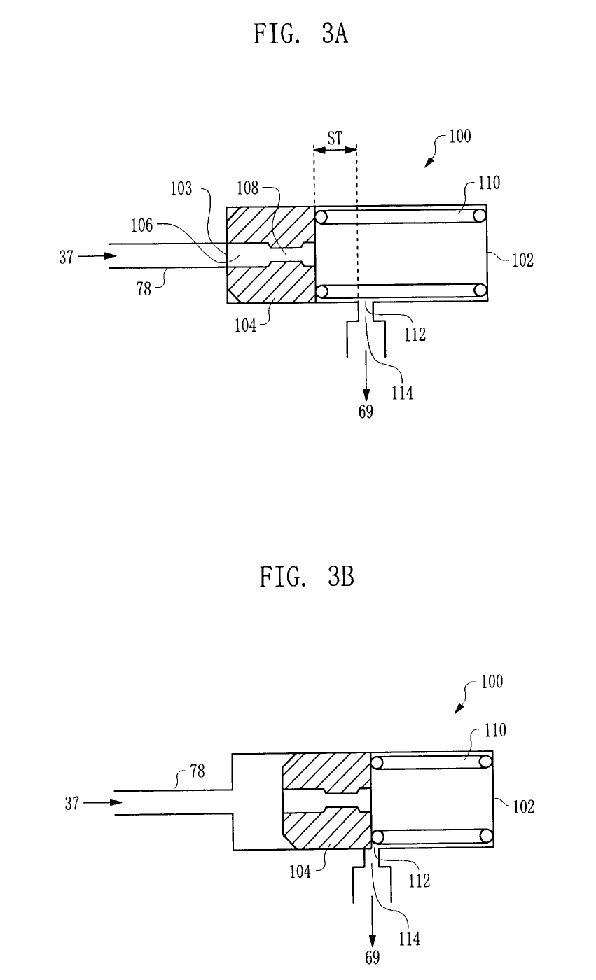

FIG. 3A and FIG. 3B depict the inner structure of the variable throttle mechanism 100, respectively. The variable throttle mechanism 100 includes a movable member 104 and one or more springs 110 installed in a case body 102. The inside of the case body 102 is formed in a cylindrical shape and the movable member 104 can slide in the inside of the case body 102. The case body 102 is connected to the simulator fluid passage 78 through a communicating port 103 in one end surface of the case body 102. The case body 102 is also connected to the communicating passage 114 through a communicating port 102 in the side surface of the case body 102. The stroke simulator 69 for generating the pedal resistance is connected to the communicating passage 114. The spring 110 is arranged in the inside of the case body 102, wherein one end of the spring 110 contacts with the end surface of the case body 102 in the side at which the communicating port 103 is not formed and the other end of the spring 110 contacts with the bottom surface of the movable member 104. The spring 110 presses the movable member 104 in the direction facing the end surface of the case body 102 at which the communicating port 103 is formed. Thus, a state where the movable member 104 is pressed in the end surface of the case body 102 by spring 110 may be maintained when the brake pedal 24 is not depressed.

FIG. 3A depicts a state where the movable member 104 is pressed in the end surface of the case body 102 by spring 110. The spring 110 functions as pressing unit for placing the movable member 104 in a predetermined position. A through passage 106 is formed in the movable member 104, wherein the through passage 106 guides the brake fluid from the simulator fluid passage 78 to the inside of the case body 102 and furthermore supplies the brake fluid from the communicating port 112 to the stroke simulator 69 through the communicating passage 114. A throttle 108 is formed in the through passage 106.

In the present embodiment, when the brake pedal 24 is depressed, the increase in the master cylinder pressure due to the depression of the brake pedal 24 operates on the movable member 104 from the communicating port 103. The brake fluid flows in the inside of case body 102 through the through passage 106. At this time, the throttle 108 or a throttle portion formed in the middle of the through passage 106 generates a differential pressure between the front and the rear of the movable member 104. When the differential pressure exceeds a predetermined value, the movable member 104 slides in the direction of the communicating port 112 against a pressing force of the spring 110. The distance from the position where the movable member 104 is pressed in the end surface of the case body 102 to a position where the movable member 104 reaches the edge of the communicating port 112 is set to a predetermined distance. This distance corresponds to an invalid stroke ST. The invalid stroke ST is the distance from the position of the bottom surface of the movable member 104 in the state where the movable member 104 is pressed in the end surface of the case body 102 to the edge portion of the communicating port 112.

FIG. 3B depicts a state where the movable member 104 closes a portion of the communicating port 112. At this time, the movable member 104 has moved beyond the invalid stroke ST from an end surface contact position. As described above, when the movable member 104 moves beyond the invalid stroke ST, a portion of the communicating port 112 is closed and the fluid passage area is changed. That is, the fluid passage area means a cross-section area in the fluid passage. Specifically, an opening area of the communicating port 112 is narrowed, to thereby throttle the communicating passage 114. The spring and the differential pressure generated between the front and the rear of the movable member 104 determine the distance that the movable member 104 moves.

As described above, the distance that the movable member 104 moves is determined in response to the flow rate of the brake fluid and exceeds the invalid stroke ST when the supplying flow rate of the brake fluid exceeds a predetermined flow rate. Because a portion of the communicating port 112 is closed in this time, the fluid passage area of the communicating passage 114 is changed and an inflow resistance of the brake fluid is larger. In the variable throttle mechanism 100, the flow rate sensitive type throttle mechanism of the brake fluid may be implemented by the relatively simple structure consisting of the movable member 104 and the spring 110. Because the variable throttle mechanism 100 directly varies the throttle by moving the movable member 104 unlike the feedback control using an electromagnetic valve, the variable throttle mechanism 100 responds more quickly to variations in the depression speed of the brake pedal.

The invalid stroke ST is set in accordance with the spring modulus k of the spring 110. The differential pressure generated between the front and the rear of the movable member 104 corresponds to the supplying flow rate of the brake fluid. However, it is required that a driver should feel that the pedal strongly resists moving until the differential pressure between the front and the rear of the movable member 104 reaches a target differential pressure P in the initial stage when the brake pedal is quickly depressed. Thus, it is preferable that the invalid stroke is set to be ST≧(P·A−L)/k, wherein L represents an initial load by the spring 110 in the end surface contact position of the movable member 104, A represents the fluid passage area, P represents the desired differential pressure between the front and the rear of the movable member 104, and k represents the spring modulus k of the spring 110.

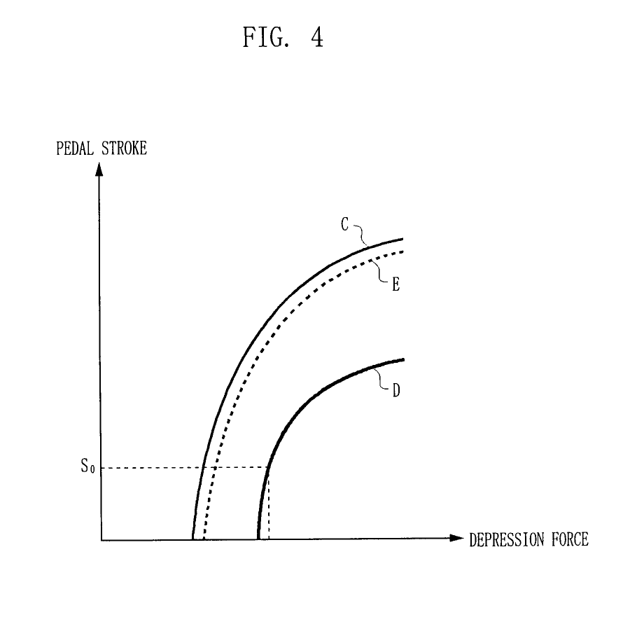

FIG. 4 represents a relation between the pedal stroke and the depression force that is required to a driver when the driver depresses the brake pedal. A characteristic curve C represents a static character in the relation between the pedal stroke and the depression force.

A characteristic curve D is a characteristic curve when a driver suddenly depresses the pedal. For example, a low brake pedal resistance is maintained until the pedal stroke exceeds S₀. This is because the movable member 104 moves in the direction toward the communicating port 112, based on the differential pressure between the front and the rear of the movable member 104 while the movable member 104 still remains in the range of the invalid stroke ST before reaching the communicating port 112. When the pedal stroke exceeds S₀, the movable member 104 reaches the communicating port 112 and gradually throttles the communicating passage 114. This allows the inflow resistance to be increased, and thus the brake pedal resistance increases.

In this way, the increases in the brake pedal resistance may be restrained until the movable member 104 reaches the communicating port 112. Therefore, it is possible to implement the brake depression that does not give an uncomfortable feeling to a driver in the initial stage when the driver quickly depresses the pedal. When the movable member 104 reaches the communicating port 112, the brake pedal resistance may be increased. Thus, a suitable braking feel can be provided to a driver.

When the differential pressure between the front and the rear of the movable member 104 fails to achieve the desired differential pressure P and the movable member 104 doesn't reach the communicating port 12 while the brake pedal 24 is depressed relatively gently, a relation between the pedal stroke and the pedal force as shown in a characteristic curve E is realized. When the brake pedal 24 is gently depressed, there is no need to increase the brake pedal resistance by throttling the communicating port 112. Thus, it is possible to obtain a suitable brake feeling in response to the speed at which the brake pedal is depressed.

While the invention has been shown and described with respect to the example embodiments, it will be understood by those skilled in the art that various changes and modification may be made without departing from the spirit and scope of the invention as defined in the following claims.

What is claimed is:

1. An apparatus that generates a brake pedal resistance in response to depression of the brake pedal, comprising:
a variable throttle mechanism coupled to an operating fluid supply passage that provides an operating fluid from a master cylinder; and
a stroke simulator that communicates with the variable throttle mechanism,
wherein the variable throttle mechanism varies a fluid passage area when a flow rate of the operating fluid supplied from the master cylinder exceeds a predetermined flow rate.

2. The apparatus according to claim 1, wherein the variable throttle mechanism varies the fluid passage area of a fluid passage that connects the variable throttle mechanism with the stroke simulator.

3. The apparatus according to claim 1, wherein the variable throttle mechanism includes a movable member in which a through passage for the operating fluid is formed; and
wherein a throttle structure is provided in the through passage.

4. The apparatus according to claim 3, wherein the throttle structure includes a small-diameter passage, of which diameter is smaller than the other passages in the through passage.

5. The apparatus according to claim 3, wherein the movable member is slidably mounted on the inside of a case body; and
wherein the movable member varies the fluid passage area by closing a portion of a communicating port which is formed in the case body, and which communicates with the stroke simulator.

6. The apparatus according to claim 5, wherein the variable throttle mechanism includes a pressing unit for pressing the movable member to a predetermined position of the inside of the case body; and
wherein the distance from the predetermined position to the communicating port is set as a predetermined distance.

7. The apparatus according to claim 6, wherein the pressing unit includes one or more springs; and
wherein the predetermined distance is set according to a spring modulus of the spring.

8. The apparatus according to claim 6, wherein a rate of increase in the brake pedal resistance is maintained low until the movable member moves to exceed the predetermined distance, and the rate of increase in the brake pedal resistance is progressively increased as the movable member moves beyond the predetermined distance.

9. The apparatus according to claim 6, wherein the movable member varies the fluid passage area when the movable member moves beyond the predetermined distance.

10. The apparatus according to claim 5, wherein the through passage directs the operating fluid from the operating fluid supply passage to the inside of the case body and the operating fluid is supplied to the stroke simulator via a communicating port.

11. The apparatus according to claim 3, wherein the movable member slides based on a differential pressure generated between the front and the rear of the throttle structure.
